(19) United States
(12) Patent Application Publication
(10) Pub. No.: US 2012/0234770 A1
(43) Pub. Date: Sep. 20, 2012

(54) FILTER ASSEMBLY AND CONTROL SYSTEM

(76) Inventor: Christopher L. Goodwin, Seattle, WA (US)

(21) Appl. No.: 13/352,199

(22) Filed: Jan. 17, 2012

Related U.S. Application Data
(60) Provisional application No. 61/433,871, filed on Jan. 18, 2011.

(51) Int. Cl. B01D 35/147; B01D 37/04; B01D 35/143; B01D 35/14

(52) U.S. Cl. 210/739; 210/130; 210/541

(57) ABSTRACT

Filter assemblies, components and systems are provided with a bypass mechanism that allows fuel or other fluids to bypass a filter media of a filter upon a fault condition thereby allowing, for example, a combustion engine receiving fuel to continue to operate without interruption or loss of power in the event of fuel contamination and/or obstruction of the filter media. This advantageously allows an operator to bring a vehicle, vessel or equipment utilizing the engine to a safe condition prior to servicing the filter and inspecting other components of the filter system.

### BACKGROUND

1. Technical Field

This disclosure generally relates to the field of internal combustion engines, and more particularly, to fuel filtration systems of internal combustion engines.

2. Description of the Related Art

Typical engines are fitted with one or more fuel filters. A first or primary fuel filter is often located between the fuel tank and the fuel pump and a second or secondary fuel filter, if equipped, is often located after the fuel pump and upstream of a fuel injection system. The filters are intended to remove suspended water and particulate matter before they enter the fuel injection system.

In typical fuel filtration systems there is little or no feedback providing fuel filter status to the engine operator and generally the first indication of a fault condition is loss of power or engine failure. The engine must then be stopped if it has not already stopped from fuel starvation, or worse, and the fuel filter serviced, often at an inopportune time.

If the fuel filter becomes unexpectedly plugged, the fuel system vacuum increases as the fuel pump or fuel injection system tries to draw fuel through a restricted fuel filter. Fuel supply and pressure decrease and system vacuum increases as the flow of fuel through the filter is restricted. Increased vacuum in the fuel system can cause catastrophic failure of fuel pumps or injection components of the fuel injection system or a rupture of the media of the fuel filter rendering it useless. If water builds up in the filter housing it can cause the filter media to plug or bypass the filter media and allow water to be sent on to the fuel injection system risking catastrophic failure of fuel pumps and injector components.

### BRIEF SUMMARY

Embodiments of the fuel filter assemblies, components and systems for internal combustion engines described herein provide an engine operator with information as to the condition of a fuel filter and automatically remove the fuel filter from the fuel system upon a fault condition, trapping in the particulate matter responsible for filter plugging and/or water that is contaminating the fuel. This allows the engine to continue running utilizing its primary filtration system long enough to bring a vehicle, vessel or equipment utilizing the engine to a safe condition prior to servicing the fuel filter. In this manner, operator safety is enhanced and vital engine components are protected.

In one embodiment, a fuel filter assembly is provided comprising a manifold with sensor ports, fuel inlet and outlet ports as well as passages interconnecting the inlet and outlet ports to other ports for routing fuel through a filter media of the filter assembly. A bypass valve assembly is coupled to the manifold to route fuel through the filter media, or alternatively, to bypass the filter media entirely. The filter assembly further includes a vacuum sensor and a water in fuel (WiF) sensor. The vacuum sensor and WiF sensor are electrically coupled to a control system that is configured to activate a solenoid of the bypass valve assembly in response to fault signals generated by the sensors and transition the bypass valve to a filter media bypass position. A display unit and/or alarm system may be provided to communicate one or more of the fault conditions to an operator. The display unit may be on the control panel of a vehicle, vessel or other equipment, for example, or other suitable location for alerting the operator. In addition, the control system may include a filter controller to communicate with various wired or wireless monitoring and feedback systems. For example, the filter controller may communicate with equipment rental or service centers via communication networks to allow efficient recognition of fault conditions and tracking and servicing of the same. A cellular or other radio transmitter or other wireless communication devices and components may be included to facilitate such remote identification, tracking and servicing activities.

In operation, a fuel line delivers fuel from a fuel tank or fuel source to an inlet of the fuel filter assembly. In normal operation, the fuel passes through the bypass valve to a filter media inlet, through a chamber housing the filter media, through an outlet of the filter media chamber, and exits the fuel filter assembly via a fuel outlet. The fuel continues on downstream to other components of the fuel system and ultimately to an internal combustion engine.

However, according to one embodiment, if the vacuum sensor coupled to the filter assembly senses a vacuum at or beyond a predetermined threshold level, the sensor generates a fault signal indicative of an obstructed or partially obstructed filter media. In an alternate embodiment, pressure sensors may be arranged to sense a pressure differential across the filter media to generate a fault signal indicative of an obstructed or partially obstructed filter media when the pressure differential is outside a predetermined specification. In either event, in response to the fault signal, the bypass valve is actuated by the control system to block access to the filter media inlet and route fuel entering the inlet port to the outlet port without passing through the filter media. In this manner, unfiltered fuel is directed downstream to enable the fuel system to continue to supply fuel to the engine during the fault condition. The control system may also simultaneously illuminate an indicator light (e.g., a “Vacuum” light) or other visual indicator and optionally sound an alarm. The alarm (when present) may be silenced by pressing a button or the like, however, the filter assembly preferably remains in the fault condition allowing fuel to bypass the filter media until the control system has been reset and the fault condition alleviated. Upon servicing of the filter assembly and alleviation of the fault condition, the bypass valve is actuated by the control system to allow fuel to be filtered again by the filter assembly.

Similarly, if the WiF sensor detects the presence of water above an acceptable level, the sensor generates a fault signal indicative of contaminated fuel. In response to the fault signal, the bypass valve is actuated by the control system to block access to the filter media inlet and route fuel entering the inlet port to the outlet port without passing through the filter media. In this manner, unfiltered fuel is directed downstream to enable the fuel system to continue to supply fuel to the engine during the fault condition. The controller may simultaneously illuminate an indicator light (e.g., a “Water in Fuel” light) or other visual indicator and optionally sound an alarm. The alarm (when present) may be silenced by pressing a button or the like, however, the filter assembly preferably remains in the fault condition allowing fuel to bypass the filter media until the control system has been reset and the fault condition alleviated. Upon servicing of the filter assembly and alleviation of the fault condition, the bypass valve is actuated by the controller to allow fuel to be filtered again by the filter assembly.

Accordingly, the filter assembly and control system is configured to detect fault conditions (e.g., filter media obstructions and fuel contamination) and remove the filter media from a flow of fuel which may be uninterruptedly supplied to an engine downstream of the filter assembly during the presence of such fault conditions.

### BRIEF DESCRIPTION OF THE SEVERAL VIEWS OF THE DRAWINGS

FIG. 1 is a schematic diagram of a fuel filtration system for an internal combustion engine, according to one embodiment.

FIG. 2A is a diagram of a filter assembly, according to one embodiment, usable in the fuel filtration system of FIG. 1 and shown in a filtering configuration.

FIG. 2B is a diagram of the filter assembly of FIG. 2A shown in a bypass configuration.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and manufacturing techniques associated with fuel filters/separators and fuel filtration systems may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

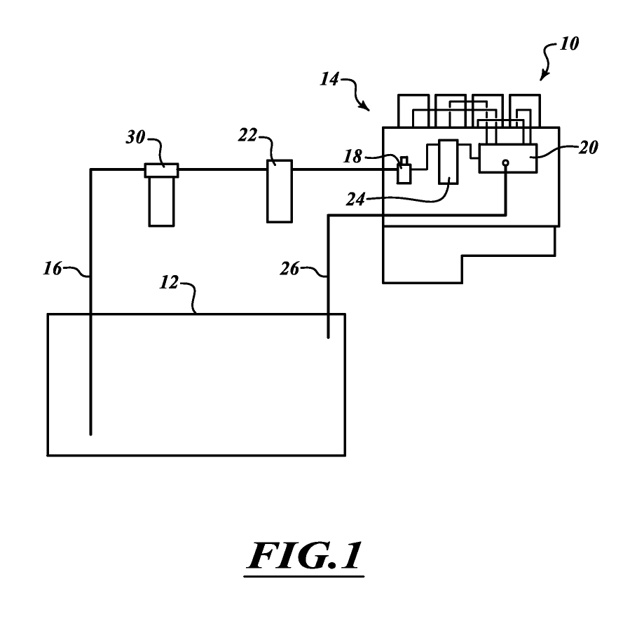

FIG. 1 illustrates a fuel filtration system 10 for an internal combustion engine, according to one embodiment. The system includes a fuel tank or reservoir 12 for supplying fuel to a combustion engine 14 by one or more fuel supply lines 16 (e.g., fuel hoses and fuel pipes). The fuel may be transported through the fuel lines 16 and into the engine 14 by one or more pumps, such as a lift pump 18 and fuel injection pump 20. En route to the engine, the fuel may pass through one or more stock filters, such as, for example, a primary fuel filter 22 located upstream of the lift pump 18 and a secondary filter 24 located upstream of the injection pump 20. A return line 26 returns unused fuel back to the fuel tank 12. The system further includes an additional filter assembly 30 having a bypass mechanism upstream of the other filter(s) 22, 24 of the fuel filtration system 10. As described in more detail below, this additional filter assembly 30 (and associated control system) is configured to detect fault conditions (e.g., filter media obstructions and fuel contamination) and remove the filter media therein from a flow of fuel to uninterruptedly supply fuel to the engine 14 during such fault conditions. In this manner, the engine 14 may continue to run utilizing other filter(s) 22, 24 long enough to bring a host vehicle, vessel or other equipment (e.g., diesel generators) to a safe condition so that the fuel filter 30 registering the default and other filters 22, 24 can be serviced or inspected.

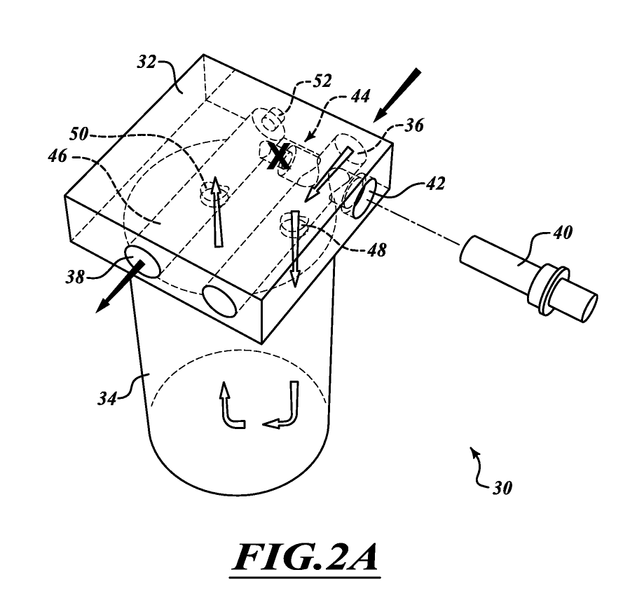

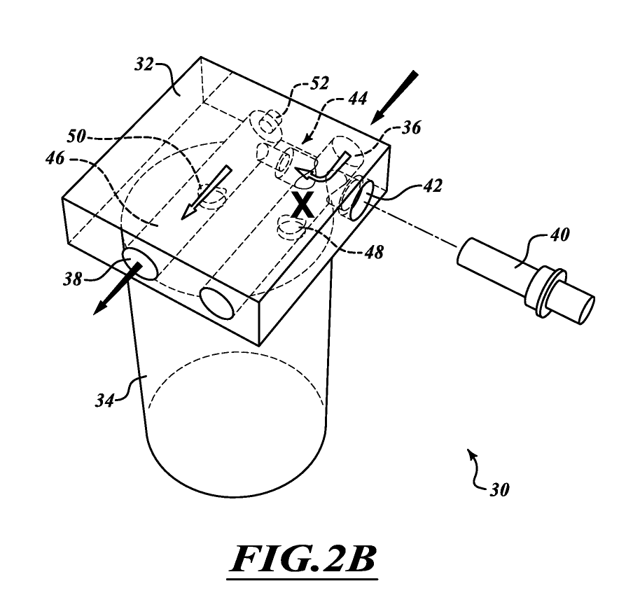

FIGS. 2A and 2B are diagrams illustrating further features of the filter assembly 30 having a bypass mechanism, according to one embodiment. The fuel filter assembly 30 includes a manifold 32 coupled to an upper portion or head of a filter body or housing 34. The manifold 32 routes fuel between a fuel inlet 36 and a fuel outlet 38 and selectively through a filter media (not shown) received in the filter body or housing 34. A bypass valve 40, such as a two-position solenoid valve (as illustrated), pneumatic valve, poppet valve or other valve, is coupled to the manifold 32. The bypass valve 40 is movable between a first filtering position and a second bypass position, the bypass valve 40 allowing fuel to flow through the filter media when in the first filtering position (depicted in FIG. 2A) and preventing fuel from flowing through the filter media when in the second bypass position (depicted in FIG. 2B).

More particularly, the manifold 32 includes a valve cavity 42 including a bypass portion 44 to pass unfiltered fuel to the fuel outlet 38 via outlet passage 46 when the bypass portion 44 of the valve cavity 42 is at least partially unobstructed. This occurs when the bypass valve 40 transitions to the second bypass position in response to a fault signal from one or more sensors monitoring the fuel system. The manifold further includes a filter media inlet 48 downstream of the fuel inlet 36 to pass fuel received via the fuel inlet 36 to the filter media when a passage through the valve cavity 42 toward the filter media inlet 48 is at least partially unobstructed. This occurs when the bypass valve 40 is in the first filtering position under normal operating conditions (i.e., no fault signals have been generated). The manifold 32 further includes a filter media outlet 50 to pass filtered fuel moving through the filter media to the fuel outlet 38 when the passage through the valve cavity 42 toward the filter media inlet 48 is at least partially unobstructed (i.e., when the bypass valve 40 is in the filtering position). In other embodiments, the bypass valve may be provided remote from the filter housing 34 and coupled thereto with appropriate fittings, hoses and/or pipes.

The manifold 32 may be a separate component that is attached to the filter body 34 or may be integrally formed therewith. The manifold 32 may be machined, cast, molded or formed via other conventional manufacturing processes. A kit may be provided including the manifold 32, the bypass valve 40, electrical harness (not shown) and other components for combining with industry standard filter bodies, such as those that may come stock with a particular vehicle, vessel or other equipment to which the filter assembly 30 is installed. In some instances, the kit may be in the form of a retrofit kit for modifying fuel filters of existing vehicles, vessels and equipment in a particularly efficient manner with minimal modification to the fuel systems thereof. In some instances, custom filter bodies may be provided in the kit in lieu of industry standard filter bodies. One or more sensors for generating fault signals to automatically actuate the bypass valve 40 may also be included in the kit.

For instance, the manifold 32 may include a sensor port 52 in fluid communication with the outlet passage 46 and filter media outlet 50 to receive a vacuum or other sensor (not shown). The sensor is preferably coupled to the sensor port 52 to generate a filter fault signal when a vacuum at or beyond a predetermined threshold level is detected in the outlet passage 46 to trigger the bypass valve 40 to transition to the second bypass position. More particularly, when the vacuum sensor senses a vacuum at or beyond a predetermined threshold level, the sensor generates a fault signal indicative of an obstructed or partially obstructed filter media. In an alternate embodiment, pressure sensors may be arranged in the manifold to sense a pressure differential across the filter media to generate a fault signal indicative of an obstructed or partially obstructed filter media when the pressure differential is outside a predetermined specification. In either event, in response to the fault signal, the bypass valve 40 is actuated by a control system to block access to the filter media inlet 48, as depicted in FIG. 2B, and to route fuel entering the inlet port 36 to the outlet port 38 via bypass portion 44, bypassing the filter media. In this manner, unfiltered fuel is directed downstream of the fuel filter assembly 30 to enable the fuel system to continue to supply fuel to the engine during the fault condition. The controller may also simultaneously illuminate an indicator light (e.g., a “Vacuum” light) or other visual indicator and optionally sound an alarm. The alarm (when present) may be silenced by pressing a button or the like, however, the filter assembly 30 preferably remains in the fault condition allowing fuel to bypass the filter media until the control system has been reset and the fault condition alleviated (e.g., by changing the filter element and/or draining water from the filter assembly). Upon servicing of the filter assembly 30 and alleviation of the fault condition, the bypass valve 40 is actuated by the control system to allow fuel to be filtered again by the filter assembly 30.

A water in fuel (WiF) sensor (not shown) is preferably received in the filter assembly to generate a filter fault signal when the presence of water above an acceptable level is detected to trigger the bypass valve 40 to transition to the second bypass position. More particularly, when the WiF sensor detects the presence of water above an acceptable level, the sensor generates a fault signal indicative of contaminated fuel. In response to the fault signal, the bypass valve 40 is actuated by the control system to block access to the filter media inlet 48 and route fuel entering the inlet port 36 to the outlet port 38 via bypass portion 44, bypassing the filter media. In this manner, unfiltered fuel is directed downstream of the filter assembly 30 to enable the fuel system to continue to supply fuel to the engine during the fault condition. The controller may simultaneously illuminate an indicator light (e.g., a “Water in Fuel” light) or other visual indicator and optionally sound an alarm. The alarm (when present) may be silenced by pressing a button or the like, however, the filter assembly 30 preferably remains in the fault condition allowing fuel to bypass the filter media until the control system has been reset and the fault condition alleviated. Upon servicing of the filter assembly 30 and alleviation of the fault condition, the bypass valve is actuated by the controller to allow fuel to be filtered again by the filter assembly 30.

A control system (not shown) including a controller and appropriate wiring harness may be provided to receive signals from the filter sensors and generate a control signal for actuating the bypass valve 40 in response thereto. The control system may be integrated with or otherwise configured to interoperate with an engine control module (ECM) or electronic control unit (ECU) of a host vehicle, vessel or other equipment (e.g., diesel generator). The control system may further control the warning lights and/or alarms described above for communicating fault conditions to an operator. The control system is also preferably configured to automatically reset the bypass valve 40 to the first filtering position upon servicing of the filter assembly 30 and alleviation of the fault condition(s). The filter assembly 30 and control system is configured to detect fault conditions (e.g., filter media obstructions and fuel contamination) and remove the filter media from a flow of fuel which may be uninterruptedly supplied to an engine downstream of the filter assembly 30 while alerting an operator to the potentially hazardous or damaging condition of the fuel system. In addition, the control system may be configured to communicate with various wired and wireless monitoring and feedback systems. For example, the control system may communicate with equipment rental or service centers via communication networks to allow efficient recognition of fault conditions and tracking and servicing of the same. A cellular or other radio transmitter or other wireless communication devices and components may be included to facilitate such remote identification, tracking and servicing activities.

The above described filter assembly 30 and control system provides a pre-filtering function which ensures that particulate matter and water that may be present in the fuel does not reach vital engine components. When the bypass valve 40 of the filter assembly 30 is triggered to its bypass position, the filter media of the filter assembly 30 is dropped from the path of fuel flow and the particulate matter and/or water which triggered the bypass condition is substantially trapped within the filter body or housing 34. In this bypass condition, unfiltered fuel may be routed to one or more stock filters 22, 24 of a host vehicle, vessel or other equipment. The stock filters 22, 24 may thereby temporarily serve as the only filtration means while the one or more fault conditions are present. This allows an operator to safely bring the host vehicle, vessel or other equipment a safe condition prior to servicing the clogged and/or contaminated fuel filter 30. The filter assembly 30 with bypass valve thus advantageously serves as a primary line of defense protecting the stock filter, the fuel injection system and the safety and schedule of the downstream engine.

Furthermore, the filter assembly 30 and control system is advantageously configured to alert operators to fault conditions, thus prompting filter servicing when needed rather than at predefined intervals which may not reflect actual servicing needs (as is otherwise typical). With the filter assembly 30 and systems described herein, replacement of the filter or filter media can more accurately reflect the condition of the filter without facing the risk of untimely or importune loss of power or engine stall from contaminated fuel or obstructed flow.

According to some embodiments, a filter system is provided comprising a filter and a control unit. While there is no reason that the control unit could not be integrated into the filter, it is preferable to locate the control unit remote from the potentially harsh environments, such as an engine compartment. Accordingly, in some embodiments, the control unit may be integrated into a gauge assembly or control panel of a host vehicle, vessel or other equipment. The control unit may also be integrated into an engine control module (ECM) or electronic control unit (ECU) that controls the vehicle and/or engine.

As previously mentioned, the filter system may also be integrated with remote monitoring services and devices. In this manner, the filter system enables an equipped engine to be monitored via the internet, dedicated call back numbers or programs via cellular networks. Thus, fleet owners can locate vehicles, check on the speed, oil and coolant temp and now the condition of fuel systems. For instance, when the filter system detects a fault and locks the filter media out of the fuel system it can send a message to the monitoring equipment to initiate it to report the fault and alert the operator. This scenario is particularly helpful if equipment is being operated remotely, like a mountain top communications repeater or a back-up generator where one company may hold service contracts for dozens of units which are installed with the filter system. Rental and leasing companies may also benefit from this feature when they are alerted to fuel system conditions created by those using the equipment, such as, for example, construction sites where equipment is refilled from contaminated skid tanks. In this scenario, the company can then contact the equipment renter and inform them that they have contaminated the fuel on a particular piece of equipment and that it needs to be serviced, eliminating their liability and allowing them to monitor abuse. Other objects and advantages of the filter systems described herein will become clear by studying the disclosure, drawings and claims.

Furthermore, although embodiments have been described herein in terms of a filter and control system for filtering fuel, it is appreciated that aspects of the present invention are applicable to the filtering or conditioning of other fluids, such as, for example, hydraulic oil, transmission fluids, coolants, water, blood and food syrups. Accordingly, the filter and control system may be applied to devices outside of the automotive industry, such as, for example, filters for filtering blood in the medical field or filters for filtering water in the water supply industry. Thus, the present invention is by no means limited to fuel filtering applications.

Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A filter assembly, comprising:
a filter housing;
a filter media received in the filter housing; and
a bypass valve coupled to the housing, the bypass valve movable between at least a first position and a second position, the bypass valve allowing fluid to flow through the filter media when in the first position and preventing fluid from flowing through the filter media when in the second position.

2. The filter assembly of claim 1 wherein the filter housing includes a fluid inlet and a fluid outlet, and wherein the bypass valve is located downstream of the fluid inlet and configured to route fluid towards the fluid outlet to bypass the filter media when the valve is in the second position.

3. The filter assembly of claim 1, further comprising:
a manifold coupled to the filter housing to receive the bypass valve.

4. The filter assembly of claim 1 wherein the bypass valve is a two-position solenoid valve.

5. The filter assembly of claim 1, further comprising:
a vacuum sensor coupled to the filter housing, the vacuum sensor configured to generate a vacuum fault signal when a threshold vacuum level is detected to trigger the bypass valve to transition to the second position.

6. The fluid filter assembly of claim 5, further comprising:
a water sensor positioned in the filter housing, the water sensor configured to generate a water fault signal when the presence of water is detected to trigger the bypass valve to transition to the second position.

7. The filter assembly of claim 6, further comprising:
an electronic control unit, the electronic control unit configured to receive the vacuum fault signal from the vacuum sensor and the water fault signal from the water sensor and control the position of the bypass valve in response thereto.

8. The filter assembly of claim 1, further comprising:
pressure sensors coupled to the housing to sense a pressure differential across the filter media and generate a fault signal when the pressure differential is outside a predetermined specification.

9. A fuel filtration system for an internal combustion engine having a primary fuel filter, the fuel filtration system comprising:
a pre-filtering fuel filter in fluid communication with the primary fuel filter and positioned upstream of the primary fuel filter; and
a bypass valve coupled to the pre-filtering fuel filter to automatically route fuel so that it bypasses a filter media of the pre-filtering fuel filter in response to one or more fault signals.

10. The fuel filtration system of claim 9, further comprising:
a vacuum sensor coupled to the pre-filtering fuel filter, the vacuum sensor configured to generate a vacuum fault signal when a threshold vacuum level is detected to trigger the bypass valve to transition to a position in which fuel bypasses the filter media of the pre-filtering fuel filter.

11. The fuel filter assembly of claim 10, further comprising:
a water in fuel sensor coupled to the pre-filtering fuel filter, the water in fuel sensor configured to generate a water fault signal when the presence of water in the fuel is detected to trigger the bypass valve to a position in which fuel bypasses the filter media of the pre-filtering fuel filter.

12. A bypass manifold for a fuel filter, comprising:
a fuel inlet to receive fuel from a fuel feed line;
a fuel outlet to let out fuel from the manifold;
a valve cavity positioned between the fuel inlet and fuel outlet and sized to receive a bypass valve, the valve cavity including a bypass portion to pass unfiltered fuel to the fuel outlet when the bypass portion of the valve cavity is at least partially unobstructed;
a filter media inlet downstream of the fuel inlet to pass fuel received via the fuel inlet to a filter media when a passage through the valve cavity toward the filter media inlet is at least partially unobstructed; and
a filter media outlet to pass filtered fuel moving through the filter media to the fuel outlet when the passage through the valve cavity toward the filter media inlet is at least partially unobstructed.

13. The bypass manifold of claim 12, further comprising:
a bypass valve received in the valve cavity, the bypass valve movable between at least a first position and a second position, the bypass valve configured to obstruct fuel from flowing through the bypass portion of valve cavity when in the first position and obstruct fuel from flowing through the filter media inlet when in the second position.

14. The bypass manifold of claim 13, further comprising:
a vacuum sensor port in fluid communication with an outlet passage and the filter media outlet.

15. The bypass manifold of claim 14, further comprising:
a vacuum sensor coupled to the vacuum sensor port, the vacuum sensor configured to generate a filter fault signal when a vacuum at or beyond a predetermined threshold level is detected in the outlet passage to trigger the bypass valve to transition to the second position.

16. A method of selectively pre-filtering fuel supplied to an internal combustion engine, the method comprising:
sensing a fault condition; and
bypassing a filter media of a fuel filter assembly in response thereto.

17. The method of claim 16 wherein sensing a fault condition includes sensing a threshold vacuum level in an outlet passage of the fuel filter assembly, and wherein bypassing the filter media includes actuating a bypass valve to obstruct a fuel path to the filter media.

18. The method of claim 16 wherein sensing a fault condition includes sensing a pressure differential across the filter media of the fuel filter assembly.

19. The method of claim 16 wherein sensing a fault condition includes sensing the presence of water in the fuel filter assembly, and wherein bypassing the filter media includes actuating a bypass valve to obstruct a fuel path to the filter media.

20. The method of claim 16, further comprising:
alerting an operator to the fault condition via a visual or auditory indicator.
